(19) United States
(12) Patent Application Publication
(10) Pub. No.: US 2026/0012314 A1
(43) Pub. Date: Jan. 8, 2026

(54) DYNAMIC ADAPTION OF CONTROL RESOURCE SET AND SEARCH SPACE PARAMETERS

(71) Applicant: Lenovo (United States) Inc., Morrisville, NC (US)

(72) Inventors: Karthikeyan Ganesan, Nauheim (DE); Ali Ramadan Ali, Kraiburg (DE); Ravi Kuchibhotla, Chicago, IL (US)

(73) Assignee: Lenovo (United States) Inc., Morrisville, NC (US)

(21) Appl. No.: 19/179,932

(22) Filed: Apr. 15, 2025

(51) Int. Cl. H04L 5/00

(52) U.S. Cl. CPC H04L 5/0053; H04L 5/0091

(57) ABSTRACT

Various aspects of the present disclosure relate to dynamic adaption of control resource set (CORESET) and search space parameters. A user equipment (UE) may receive a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs. The UE may receive an indication of one or more modified parameters based on a trigger event. The UE may monitor for a downlink communication based on the one or more modified parameters.

### TECHNICAL FIELD

The present disclosure relates to wireless communications, and more specifically to dynamic adaption of control resource set (CORESET) and search space parameters.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; receive an indication of one or more modified parameters based on a trigger event; and monitor for a downlink communication based on the one or more modified parameters.

A processor (e.g., a standalone processor chipset, or a component of a UE) for wireless communication is described. The processor may be configured to, capable of, or operable to perform one or more operations as described herein. For example, the processor may be configured to, capable of, or operable to receive a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; receive an indication of one or more modified parameters based on a trigger event; and monitor for a downlink communication based on the one or more modified parameters.

A method performed or performable by a UE for wireless communication is described. The method may include receiving a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; receiving an indication of one or more modified parameters based on a trigger event; and monitoring for a downlink communication based on the one or more modified parameters.

In some implementations of the UE, the processor, and the method described herein, each of the one or more CORESETs is associated with a respective CORESET identifier (ID), and one or more parameters of the first configuration includes one or more of a set of time resources for a respective CORESET; a set of frequency resources for the respective CORESET; or a demodulation reference signal (DMRS) density for the respective CORESET. In some implementations of the UE, the processor, and the method described herein, one or more parameters of the second configuration includes one or more of a set of slots for monitoring physical downlink control channel (PDCCH); a subset of slots for multi-slot monitoring PDCCH; a beginning symbol of a respective slot for monitoring PDCCH; a quantity of PDCCH candidates per aggregation level (AL) for a respective search space; or a quantity of ALs for the respective search space.

In some implementations of the UE, the processor, and the method described herein, the first set of parameters or the second set of parameters includes multiple subsets of parameters, each subset of the multiple subsets of parameters including at least one same parameter, where a value assigned to the at least one same parameter differs between each subset of the multiple subsets of parameters. In some implementations, the UE, the processor, and the method may further be configured to, capable of, or operable to receive an indication to switch from a first subset of the multiple subsets of parameters to a second subset of the multiple subsets of parameters, where monitoring for the downlink communication is based on the second subset of the multiple subsets of parameters. In some implementations, the UE, the processor, and the method may further be configured to, capable of, or operable to modify a quantity of symbols for a respective CORESET based on the indication of the one or more modified parameters.

In some implementations, the UE, the processor, and the method may further be configured to, capable of, or operable to receive an indication of one or more carriers associated with the one or more modified parameters. In some implementations of the UE, the processor, and the method described herein, the trigger event includes an expiration of a timer or a change in a bandwidth part (BWP) associated with the UE.

In some implementations of the UE, the processor, and the method described herein, downlink control information (DCI), a medium access control-control element (MAC-CE), or a low power radio signal includes the indication of the one or more modified parameters.

An NE (e.g., a base station) for wireless communication is described. The NE may be configured to, capable of, or operable to perform one or more operations as described herein. For example, the NE may be configured to, capable of, or operable to transmit a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; transmit an indication of one or more modified parameters based on a trigger event; and transmit a downlink communication based on the one or more modified parameters.

A processor (e.g., a standalone processor chipset, or a component of a NE) for wireless communication is described. The processor may be configured to, capable of, or operable to perform one or more operations as described herein. For example, the processor may be configured to, capable of, or operable to transmit a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; transmit an indication of one or more modified parameters based on a trigger event; and transmit a downlink communication based on the one or more modified parameters.

A method performed or performable by an NE (e.g., a base station) for wireless communication is described. The method may include transmitting a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; transmitting an indication of one or more modified parameters based on a trigger event; and transmitting a downlink communication based on the one or more modified parameters.

In some implementations of the NE, the processor, and the method described herein, each of the one or more CORESETs is associated with a respective CORESET ID, and one or more parameters of the first configuration includes one or more of a set of time resources for a respective CORESET; a set of frequency resources for the respective CORESET; or a DMRS density for the respective CORESET. In some implementations of the NE, the processor, and the method described herein, one or more parameters of the second configuration includes one or more of a set of slots for monitoring PDCCH; a subset of slots for multi-slot monitoring PDCCH; a beginning symbol of a respective slot for monitoring PDCCH; a quantity of PDCCH candidates per AL for a respective search space; a quantity of ALs for the respective search space; or a number of blind decoding budget, which is the maximum number of PDCCH candidates for a UE to decode.

In some implementations of the NE, the processor, and the method described herein, the first set of parameters or the second set of parameters includes multiple subsets of parameters, each subset of the multiple subsets of parameters including at least one same parameter, where a value assigned to the at least one same parameter differs between each subset of the multiple subsets of parameters. In some implementations of the NE, the processor, and the method described herein, the indication of the one or more modified parameters includes an indication to switch from a first subset of the multiple subsets of parameters to a second subset of the multiple subsets of parameters, where transmitting the downlink communication is based on the second subset of the multiple subsets of parameters.

In some implementations of the NE, the processor, and the method described herein, the indication of the one or more modified parameters includes an indication to modify a quantity of symbols for a respective CORESET.

In some implementations, the NE, the processor, and the method may further be configured to, capable of, or operable to transmit an indication of one or more carriers associated with the one or more modified parameters. In some implementations of the NE, the processor, and the method described herein, the trigger event includes an expiration of a timer or a change in a BWP associated with a UE. In some implementations of the NE, the processor, and the method described herein, DCI, a MAC-CE, or a low power radio signal includes the indication of the one or more modified parameters.

### BRIEF DESCRIPTION OF THE DRAWINGS

FIG. 1 illustrates an example of a wireless communications system in accordance with aspects of the present disclosure.

FIG. 2 illustrates an example of a wireless communications system in accordance with aspects of the present disclosure.

FIGS. 3A, 3B, and 3C illustrate examples of a signal format in accordance with aspects of the present disclosure.

FIGS. 4A and 4B illustrate examples of a signal format in accordance with aspects of the present disclosure.

FIG. 5 illustrates an example of a discontinuous reception (DRX) timeline in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates an example of a flowchart of a method performed by a UE in accordance with aspects of the present disclosure.

FIG. 10 illustrates an example of a flowchart of a method performed by an NE in accordance with aspects of the present disclosure.

FIG. 11 illustrates an example of a process flow in accordance with aspects of the present disclosure.

### DETAILED DESCRIPTION

A UE may receive control information from an NE (e.g., a base station). To monitor for and receive the control information from the NE, the UE may be configured with a CORESET. The CORESET may be described as resources (e.g., time and frequency resources) that the UE may use to receive the control information from the NE. In addition to the CORESET, the UE may be configured with a search space corresponding to the CORESET. The search space may be a region within the CORESET that the UE monitors to detect specific control information. In conventional systems, parameters that define the CORESET and the corresponding search space remain constant (e.g., static). However, in some cases, it may be beneficial for the UE to modify or update the parameters. For example, if the UE undergoes a BWP change (e.g., switch from a first BWP to a second BWP), it may be beneficial to increase or decrease a quantity of resources (e.g., symbols, slots) allocated to the CORESET. In some cases, UE performance may be impacted, such as by an inability to adapt to the data traffic load, which may lead to more blocking issues when the CORSET resources (e.g., symbols) are less, while more CORESET resources (e.g., symbols) can lead to a loss of spectral efficiency.

The techniques as described herein may allow for adaptation of CORESET or search space parameters. The UE may receive, from the NE, a configuration (or a set of configurations) that indicate a set of parameters that defines a CORESET and a search space that the UE may utilize to receive control information from the NE. The set of parameters may include one or more of a quantity of symbols for the CORESET, a DMRS density for the CORESET, etc. The UE or the NE may adapt one or more of CORESET or search space parameters based at least in part on a trigger event. For example, the UE or the NE may detect an expiration of timer or a BWP change. In response to (or based at least in part on) the trigger event, the UE may receive, from the NE, an indication (e.g., via DCI, MAC-CE, or RRC) of one or more modified parameters (e.g., one or more modifiable parameters) of the set of parameters. As an example, the indication may identify to increase a quantity of symbols for the CORESET from two (2) symbols to three (3) symbols. The UE may modify the one or more parameters as indicated by the indication and monitor for the control information from the NE in accordance with the one or more modified parameters. In other implementations, an NE (e.g., base station) may provide a parameter set or updated values to one or more UEs while also specifying the condition as to when such values or parameter set can be used. For example, the NE may signal two parameter sets, where one parameter set contains a two (2) symbol CORSET associated with a larger BWP bandwidth, and another parameter set contains a three (3) symbol CORESET associated with the smaller BWP bandwidth. When the BWP adaptation event is triggered, the UE autonomously switches CORESET parameters, or uses the updated parameters.

By performing the described techniques, the UE may dynamically adapt CORESET or search space parameters in response to changing conditions at the UE (e.g., a BWP change in response to network energy savings (NES) or a change in load/traffic conditions) which may increase a performance of the UE (e.g., longer battery life, efficient resource utilization, improved user experience related to reduced processing) as compared to other techniques.

Aspects of the present disclosure are described in the context of a wireless communications system. Additional aspects of the present disclosure are described in the context of signal formats, component diagrams, process flows, method flows, etc. It should be understood that various terms may be used interchangeably with “communicating,” such as “signaling,” “transmitting,” “receiving,” “outputting,” “forwarding,” “relaying,” “retrieving,” “obtaining,” and so forth.

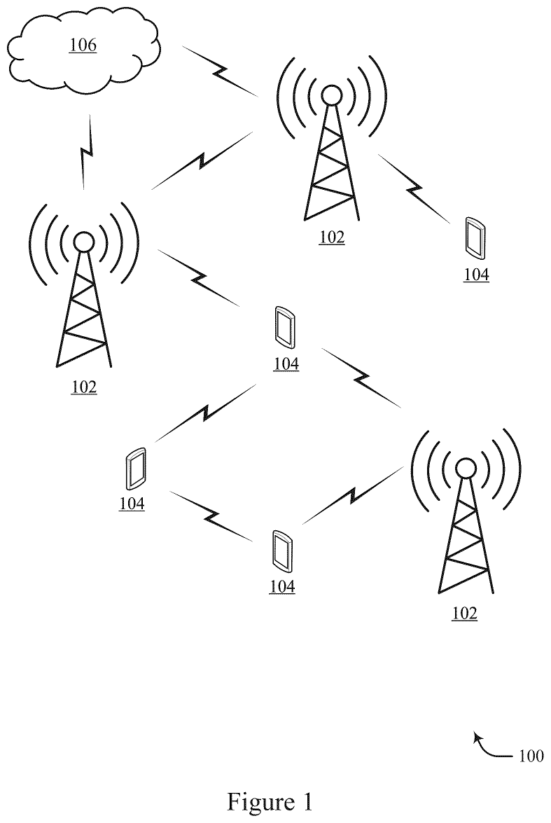

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FRI may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the UE 104 may be equipped with a low power-wake up radio (LP-WUR) and a main radio (MR), e.g., a 5G MR. The LP-WUR may operate independent of the MR. For example, the MR can sleep (or be powered off) while the LP-WUR is awake (or powered on) and searching for low power-wake up signals (LP-WUSs). This allows the MR to sleep during a DRX ON-duration if the LP-WUR does not receive a LP-WUS prior to the DRX ON-duration. Alternatively, if the LP-WUR does receive the LP-WUS prior to the DRX ON-duration, the LP-WUR may be operable to wake up (or power on) the MR such that the MR may monitor for data during the DRX ON-duration.

In some examples, the UE 104 may receive a BWP configuration that includes a CORESET information element (IE) and a search space IE. The CORESET IE may include parameters such as controlResourceSetId, FrequencyDomainResources, duration, etc. for a CORESET. controlResourceSetId may specify an identify of the CORESET, FrequencyDomainResources may specify frequency resources allocated to the CORESET, and duration may specify time resources (or symbols) allocated to the CORESET. The search space IE may include parameters such as searchSpaceId, controlResourceSetId, nrofCandidates, monitoringSlotPeriodicityAndOffset, monitoringSymbolsWithinSlot, SearchSpaceGroupIdList, DCI formats, monitoringSlotsWithinSlotGroup, etc. for a search space. searchSpaceId may specify an identity of the search space, controlResource SetId may specify a CORESET applicable for the search space, SearchSpaceGroupIdList may specify a list of search space group IDs which the search space is associated with, monitoringSlotPeriodicityAndOffset may specify slots for PDCCH monitoring configured as periodicity and offset, nrofCandidates may specify a quantity of PDCCH candidates, monitoringSlotsWithinSlotGroup may specify which slots within a slot group are configured for multi-slot PDCCH monitoring, monitoringSymbolsWithinSlot may specify the first symbol(s) for PDCCH monitoring in the slots configured for (multi-slot) PDCCH monitoring,

The techniques as described herein may allow for the UE 104 to dynamically update one or more CORESET parameters or one or more search space parameters. The UE 104 may receive, from the NE 102, a configuration (e.g., the BWP configuration) that indicates a set of parameters that defines a CORESET and a search space that the UE 104 may utilize to receive control information from the NE 102. Later, the UE 104 or the NE 102 may detect a trigger event. For example, the UE 104 or the NE 102 may detect an expiration of timer or a BWP change. In response to the trigger event, the UE 104 may receive, from the NE 102, a signal indicating a modification to one or more parameters of the set of parameters. As an example, the signal may indicate to increase a quantity of symbols allocated to the CORESET from 2 symbols to 3 symbols. The UE 104 may modify the one or more parameters as indicated by the signal and monitor for the control information from the NE 102 in accordance with the one or more modified parameters.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

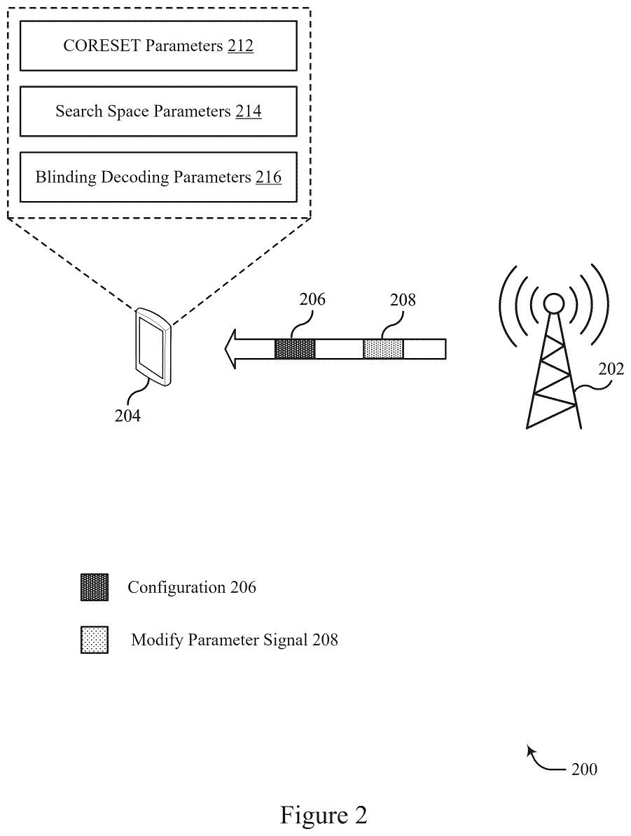

FIG. 2 illustrates an example of a wireless communications system 200 in accordance with aspects of the present disclosure. In some examples, the wireless communications system 200 may support aspects of the wireless communications system 100. For example, the wireless communications system 200 may include a UE 204 and a NE 202 which may be examples of the UE 104 and the NE 102 as described with reference to FIG. 1, respectively.

As shown in FIG. 2, the UE 204 receives a configuration 206 (or a set of configurations) that indicates parameters that define at least one CORESET and a search space corresponding to the at least one CORESET for monitoring control information. For example, the configuration 206 may indicate CORESET parameters 212, search space parameters 214, and blind decoding parameters 216. The CORESET parameters 212 may include one or more of a set of time resources, a set of frequency resources, or a DMRS density for one or more CORESETs (e.g., corresponding to a CORESET ID or CORESET group ID). The search space parameters 214 may include an indication of slot(s) configured for control information monitoring, an indication of which slots within a slot group are configured for control information monitoring, or an indication of a starting symbol for control information monitoring in the slot(s) for one or more search spaces (e.g., corresponding to a search space ID or a search space group ID). The blind decoding parameters 216 may include a quantity of PDCCH candidates per AL, a quantity of ALs, a quantity of DCI formats for the one or more search spaces, or the number of blind decoding budget, and whether to apply the blind decoding budget in a single slot or in a group of consecutive slots. The search spaces can be defined according to single slot or in multiple slots. A span is consecutive CORESET symbols to monitor a search space in a single slot. A span may also be configured in multiple slots in a subset of symbols, and each slot can be configured as part of a span. The configuration 206 may be an example of the BWP configuration as described with reference to FIG. 1. In some examples, the configuration 206 may include default values for the parameters and may be provided to the UE 204 using semi-static signaling.

During operation, the UE 204 may modify one or more parameters of the parameters. To modify the one or more parameters, the UE 204 may receive, from the NE 202, a signal 208. The signal 208 may include an indication (e.g., command, instruction) to modify (e.g., update, adjust) the one or more parameters. As an example, the signal 208 may indicate to increase or decrease a quantity of symbols allocated to a CORESET. In addition, the signal 208 may indicate which carrier(s) (e.g., one or more primary carriers or one or more secondary carriers) that the one or more parameters should be modified. The signal 208 may be an example of dedicated signaling (e.g., directed to a single UE 204) or group common signaling (e.g., directed to multiple UEs 204). After receiving the signal 208, the UE 204 may modify the one or more parameter and communicate with the NE 202 in accordance with the one or more modified parameters. For example, the UE 204 may monitor for control information using the CORESET and the search space as defined by the one or more modified parameters. In some examples, the UE 204 may apply the modified one or more parameters in a same time slot that the signal 208 is received or after an offset, e.g., a slot or symbol offset.

In some examples, the UE 204 may receive the signal 208 in response to a trigger event. In one example, the trigger event may include a BWP change at the UE 204. Additionally, or alternatively, the trigger event may include an expiration of a timer. In some examples, the UE 204 may activate (or initiate) the timer in response to receiving the configuration 206 and upon expiration of the timer, the UE 204 may receive the signal 208 from the NE 202. After receiving the signal 208, the UE 204 may then reactivate the timer. In some examples, the configuration 206 may indicate a duration of the timer.

In a first implementation, the parameters indicated in the configuration 206 may include multiple different sets of parameters. For example, the configuration 206 may indicate multiple sets of CORESET parameters 212 (or a CORESET switch list), multiple sets of search space parameters 214 (or a search space switch list), and/or multiple sets of blind decoding parameters 216 (or blinding decoding switch list). The multiple sets of CORESET parameters 212 may include, for example, a first set of CORESET parameters that indicates a first quantity of symbols (e.g., 2 symbols) allocated to a CORESET and a second set of CORESET parameters that indicates a second quantity of symbols (e.g., 3 symbols) allocated to the CORESET. In another example, the multiple sets of search space parameters 214 may include a first set of search space parameters that indicates first slot(s) configured for control information monitoring for a search space and a second set of search space parameters that indicates second slot(s) configured for control information monitoring for the search space. In yet another example, the multiple sets of the blind decoding parameters 216 may include a first set of blind decoding parameters that indicates first candidate ALs for a search space and a second set of blind decoding parameters that indicates second candidate ALs for the search space. In some examples, each set of the multiple sets may be associated with an index value. That is, each set of parameters included in the search space switch list, the CORESET switch list, or the blinding decoding switch list may be associated with a respective index. Further, each set of parameters may be associated with a respective CORESET ID or search space ID. Additionally, the configuration 206 may include a carrier groups list that indicates one or more serving carriers to apply the one or more parameter modifications. In some examples, a bitmap of the carrier groups list provides information on the modification of the one or more parameters in a BWP of a carrier within the carrier groups list.

According to the first implementation, the signal 208 may indicate for the UE 204 to switch from one set of parameters to another set of parameters. As an example, the signal 208 may indicate to deactivate (e.g., disabling a search space) the first set of search space parameters for the search space and activate (e.g., enabling the search space) the second set of search space parameters for the search space. To indicate the switch, the signal 208 may include an index associated with the target set of parameters (e.g., an index from the search space switch list, the CORESET switch list, or the blinding decoding switch list). For example, the signal 208 may include an index associated with the second set of search space parameters. Additionally, the signal 208 may include one or more bits indicating the applicable carriers of the carrier groups list such that the UE 204 has knowledge of which carriers to modify the one or more parameters.

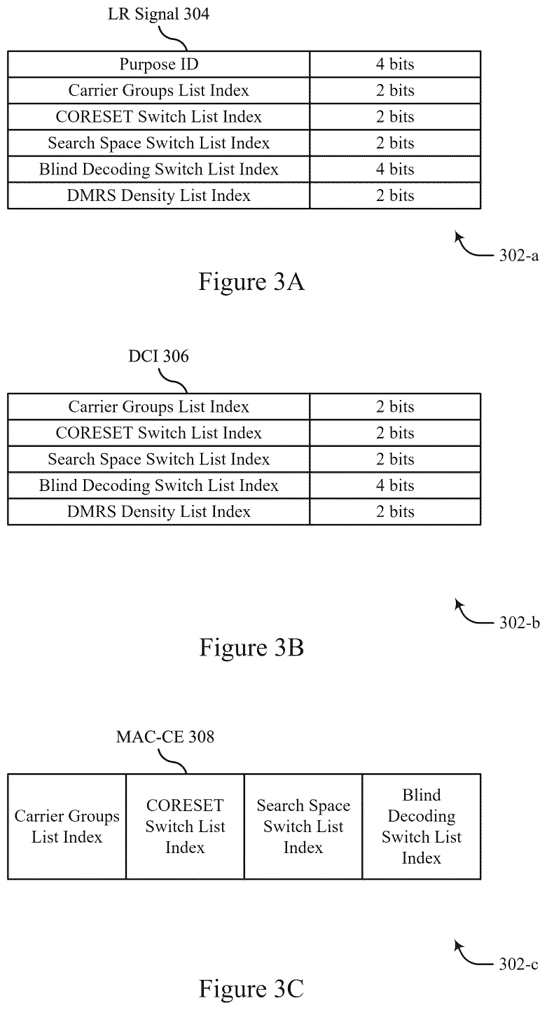

In the first implementation, the signal 208 may be provided to the UE 204 via low-power radio signaling, DCI, or a MAC-CE as described in more detail in FIGS. 3A, 3B, and 3C. In an example, the UE may support one auxiliary low power radio together with the main radio. The low power radio of the UE may monitor for one or more signaling from the NE (e.g., base station (BS)) when the main radio of the UE is in a sleep mode. The low power radio may wake up the main radio when there is any activity indicated by the BS while the main radio is in the sleep mode. The low power radio signaling utilizes the on-off keying (OOK) or a sequence-based transmission from the BS to the low power radio of the UE. The BS may configure a monitoring occasion for the low power radio separately for the reception of low power radio signaling.

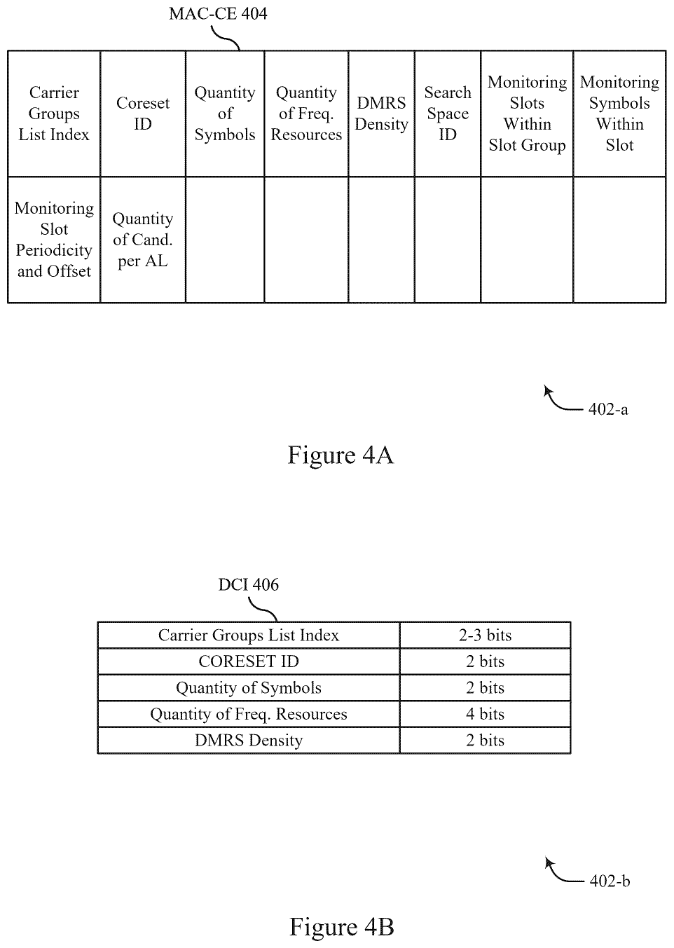

In a second implementation, the set of parameters indicated by the configuration 206 includes a set of CORESET parameters 212, a set of search space parameters 214, and/or a set of blind decoding parameters 216 and the signal 208 may indicate to selectively modify one or more parameters of at least one of these sets. As an example, the signal 208 may include an indication of applicable carriers (e.g., carriers groups list) for the parameter modification, an ID of the applicable CORESET/search space, and an indication of a target value for at least one parameter. For example, the signal 208 may include a CORESET ID followed by an index to a table that includes different symbol quantities, different DMRS densities, or different frequency resources/PRB for the CORESET ID. In such implementation, the signal 208 may be provided to the UE 204 via a MAC-CE or DCI as described in FIGS. 4A and 4B.

The NE 202 may provide the signal 208 to the UE 204 in different ways. For example, the NE 202 may provide the signal 208 as part of a wake-up indication (e.g., LP-WUS or DCI) prior to a DRX ON-duration, as part of a discontinuous transmission (DTX) configuration, as part of group common low-power radio signaling in a low-power radio occasion, as part of a group common dynamic indication (e.g., in a same slot or before N slots/symbols), as a part of a MAC-CE, or as part of common bandwidth (CBW)/BWP change signaling.

In some examples, the signal 208 may additionally or alternatively include hybrid automatic request acknowledgement (HARQ-ACK) feedback, a downlink assignment index (DAI), one or more modified transmission configuration indicator (TCI) states, indications for a physical downlink shared channel (PDSCH)/PDCCH, a PDCCH monitoring skipping indication, a PDCCH monitoring indication, a wake-up indicator of whether or not to start or not start a periodic ON-duration timer, or an indication to start an on-demand timer for a group of UEs, etc.

FIGS. 3A, 3B, and 3C illustrate examples of a signal format 302 (e.g., a signal format 302-a, a signal format 302-b, and a signal format 302-c) in accordance with aspects of the present disclosure. In some examples, the signal format 302 may be implemented by aspects of the wireless communications system 100 and the wireless communications system 200. For example, the signal format 302 may be implemented by the UE 104, the UE 204, the NE 102, or the NE 202 as described with reference to FIGS. 1 and 2.

In a first implementation, FIG. 2 describes that a UE may receive a configuration that includes multiple sets of parameters. The configuration includes a CORESET switch list that indicates different CORESET parameter sets as well as a corresponding index for each CORESET parameter set. Additionally, or alternatively, the configuration includes a search space switch list that indicates different search space parameter sets as well as a corresponding index for each search space parameter set. Additionally, or alternatively, the configuration may include a blind decoding switch list that indicates different sets of blind decoding parameters and a corresponding index for each blind decoding parameter set. In some examples, each set of parameters included in a switch list may include at least one same parameter, but a value of the parameter may change from one set to the next in the switch list. In additional to the multiple sets of parameters, the configuration may include a carrier groups list that indicates different groupings of carriers as well as a corresponding index for each grouping of carriers. Further, the configuration may include a DMRS density list that indicates multiple different DMRS densities as well as a corresponding index for each DMRS density.

After receiving the configuration, the UE may receive a signal that indicates to switch from one parameter set to another parameter set. To indicate the switch, the signal may include an indication of a target parameter set. For example, the signal may include an indication of an index from the CORESET switch list, the search space switch list, and/or the blind decoding switch list. In response to the signal, the UE may activate the target parameter set for a specified group of carriers within the carrier groups list.

In the example of FIG. 3A, the parameter modify signal may be included in a low power radio signal 304. As shown in FIG. 3A, the low power radio signal 304 may include a purpose ID field, a carrier groups list index field, a CORESET switch list index field, a search space switch list index field, a blind decoding switch list index field, and a DMRS density list index field. The purpose ID field may include one or more bits (e.g., 4 bits) that indicates a purpose of the low power radio signal 304. As an example, the purpose ID field may indicate that a purpose of the low power radio signal 304 is for parameter modification. The carrier groups list index may include one or more bits (e.g., 2 bits) that indicate an index that corresponds to a group of carriers included in the carrier groups list. The CORESET switch list index field includes one or more bits (e.g., 2 bits) that indicates an index that corresponds to a set of CORESET parameters in the CORESET switch list. The search space switch list index field includes one or more bits (e.g., 2 bits) that indicates an index that corresponds to a set of search space parameters in the search space switch list. The blind decoding switch list index field includes one or more bits (e.g., 4 bits) that indicates an index that corresponds to a set of blind decoding parameters in the blind decoding switch list. The DMRS density list index field includes one or more bits (e.g., 2 bits) that indicates an index the corresponds to a DMRS density in the DMRS density list.

In the example of FIG. 3B, the parameter modify signal may be included in DCI 306. As shown in FIG. 3B, DCI 306 may include a carrier groups list index field, a CORESET switch list index field, a search space switch list index field, a blind decoding switch list index field, and a DMRS density list index field. The carrier groups list index may include one or more bits (e.g., 2 bits) that indicate an index that corresponds to a group of carriers included in the carrier groups list. The CORESET switch list index field includes one or more bits (e.g., 2 bits) that indicates an index that corresponds to a set of CORESET parameters in the CORESET switch list. The search space switch list index field includes one or more bits (e.g., 2 bits) that indicates an index that corresponds to a set of search space parameters in the search space switch list. The blind decoding switch list index field includes one or more bits (e.g., 4 bits) that indicates an index that corresponds to a set of blind decoding parameters in the blind decoding switch list. The DMRS density list index field includes one or more bits (e.g., 2 bits) that indicates an index the corresponds to a DMRS density in the DMRS density list.

In the example of FIG. 3C, the parameter modify signal may be included in a MAC-CE 308. As shown in FIG. 3C, the MAC-CE 308 may include a carrier groups list index field, a CORESET switch list index field, a search space switch list index field, and a blind decoding switch list index field. The carrier groups list index may include one or more bits that indicate an index that corresponds to a group of carriers included in the carrier groups list. The CORESET switch list index field may include one or more bits that indicates an index that corresponds to a set of CORESET parameters in the CORESET switch list. The search space switch list index field may include one or more bits that indicates an index that corresponds to a set of search space parameters in the search space switch list. The blind decoding switch list index field includes one or more bits that indicates an index that corresponds to a set of blind decoding parameters in the blind decoding switch list.

FIGS. 4A and 4B illustrates examples of a signal format 402 (e.g., a signal format 402-a and a signal format 402-b) in accordance with aspects of the present disclosure. In some examples, the signal format 402 may be implemented by aspects of the wireless communications system 100 and the wireless communications system 200. For example, the signal format 402 may be implemented by the UE 104, the UE 204, the NE 102, or the NE 202 as described with reference to FIGS. 1 and 2.

In a second implementation, FIG. 2 describes that a UE may receive a configuration that includes default values for a set of parameters. For example, the configuration includes default values for a set of CORESET parameters, a set of search space parameters, and/or a set of blind decoding parameters. In addition to the default values for the set of parameters, the configuration may also include a carrier groups list that indicates different groupings of carriers as well as a corresponding index for each grouping of carriers. As described in FIG. 2, after receiving the configuration, the UE may receive a signal that indicates to selectively modify one or more parameters of the set of parameters. In response to the signal, the UE may modify the one or more parameters for a specified group of carriers within the carrier groups list.

In the example of FIG. 4A, the parameter modify signal may be included in a MAC-CE 404. As shown in FIG. 4A, the MAC-CE 404 may include a carrier groups list index, a CORESET ID field, a quantity of symbols field, a quantity of frequency resources field, a DMRS density field, a search space ID field, a monitoring slots within slot group field, a monitoring symbols within slot field, a monitoring slot periodicity and offset field, and a quantity of candidates per aggregation field. The carrier groups list index may include one or more bits that indicate an index that corresponds to a group of carriers included in the carrier groups list. The CORESET ID field may include one or more bits that indicates a CORESET ID or a CORESET group ID specifying one or more CORESETs. The quantity of symbols field may include one or more bits that indicate a quantity of symbols allocated to the one or more CORESETs. The quantity of frequency resources field may include a quantity of frequency resources allocated to the one or more CORESETs. The CORESET DMRS density field may include one or more bits that indicates a DMRS density for the one or more CORESETs.

The search space ID field may include one or more bits that indicate a search space ID or a search space group ID specifying one or more search spaces. The monitoring symbols within slot field may include one or more bits that indicate an index from monitoringSymbolsWithinSlot for the one or more search spaces. The monitoring slots within slot group field may include one or more bits that indicates an index from monitoringSlotsWithinSlotGroup for the one or more search spaces. The monitoring slot periodicity and offset field may include one or more bits that indicate an index from monitoringSlotPeriodicityAndOffset for the one or more search spaces. The quantity of candidates per ALs includes one or more bits that indicates a quantity of PDCCH candidates per AL for the one or more search spaces.

In some examples, there can be a priority associated with the MAC-CE 404 for prioritization of the MAC-CE 404. In addition, a field of the MAC-CE 404 may include a group common radio network temporary identifier (RNTI) to target UEs that utilize common resources (e.g., a common BWP or an initial BWP). In some examples, the MAC-CE 404 may be associated with a latency bound, e.g., 5 milliseconds within which the MAC-CE 404 may be transmitted to the UEs.

In the example of FIG. 4B, the parameter modify signal may be included in a DCI 406. As shown in FIG. 4B, the DCI 406 may include a carrier groups list index, a CORESET ID field, a quantity of symbols field, a quantity of frequency resources field, and a DMRS density field. The carrier groups list index may include one or more bits (e.g., 2-3 bits) that indicate an index that corresponds to a group of carriers included in the carrier groups list. The CORESET ID field may include one or more bits (e.g., 2 bits) that indicates a CORESET ID or a CORESET group ID specifying one or more CORESETs. The quantity of symbols field may include one or more bits (e.g., 2 bits) that indicate a quantity of symbols allocated to the one or more CORESETs. The quantity of frequency resources field may include one or more bits (e.g., 4 bits) that indicates a quantity of frequency resources allocated to the one or more CORESETs. The CORESET DMRS density field may include one or more bits (e.g., 2 bits) that indicates a DMRS density for the one or more CORESETs. In some examples, the DCI 406 may be a group common DCI associated with a group common RNTI associated with dynamic parameter modification and may be associated with a common search space, AL, and candidate location.

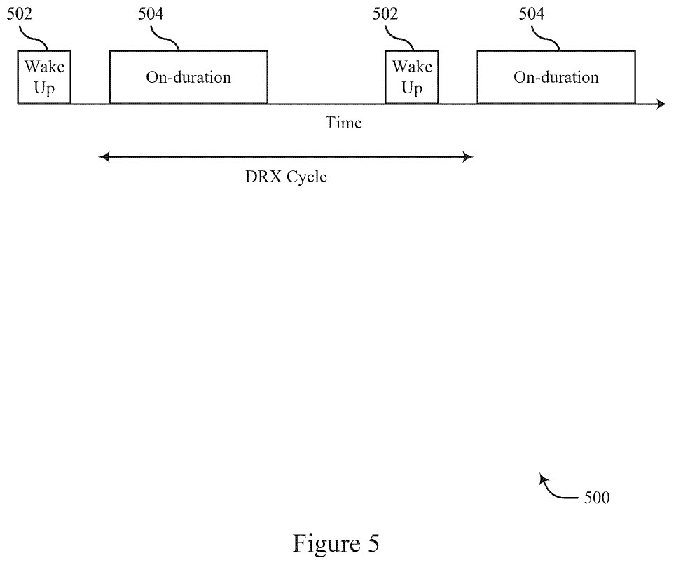

FIG. 5 illustrates an example of a DRX timeline 500 in accordance with aspects of the present disclosure. In some examples, the DRX timeline 500 may be implemented by aspects of the wireless communications system 100 or the wireless communications system 200. For example, the DRX timeline 500 may be implemented by the UE 104 or the UE 204 as described with reference to FIGS. 1 and 2, respectively.

In some examples, a UE may operate in a connected DRX (C-DRX) mode. In the C-DRX mode, the UE may receive a wake-up indication 502 (or DCI) prior to a DRX ON-duration 504. The wake-up indication 502 may indicate for the UE to wake up (or power on one or more components) during a subsequent DRX ON-duration 504 such that the UE may receive downlink signaling from an NE during the DRX ON-duration 504. In addition, the wake-up indication 502 may also include aspects of the signal as described with reference to FIGS. 1 through 4. That is, the wake-up indication 502 may include an indication to modify one or more CORESET parameters, one or more search space parameters, or one or more blind decoding parameters. As shown in FIG. 5, a single DRX cycle may include a DRX ON-duration 504 and a subsequent wake-up indication 502 of whether or not to start the DRX ON-duration timer. In this implementation, dynamic signaling may adapt the parameters of CORESET, search space, and blind decoding parameters within a search space or search space group independently. The MAC CE or group common DCI can be transmitted within the active time with a number of symbols offset to adapt to the new CORESET, search space, blind decoding parameters, or switch to the updated values.

The timer-based procedure associated with the CORESET, search space, and blind decoding parameters, after the expiry of the timer, the UE returns to the default parameters. The timer may be started when a new dynamic configuration is received, data inactivity, or power savings at the network or UE, which means after receiving the cell DTX or DRX configuration activated. When the network energy savings is activated (e.g., cell DTX or DRX), common BWP part reduction means that the cell is experiencing low traffic demand, and the network may signal adaptation of one or more CORESET, search space, and blind decoding parameters at the UE side to enable UE power savings using dynamic signaling, a timer-based procedure, or a combination thereof. In another implementation, CORESET #0 may be adapted or updated by switching to a new parameter set with increased or decreased time duration of coreset symbols and/or frequency domain resources. A master information block (MIB) may indicate a number of CORESET symbols, or an updated table index containing an updated number of CORESET symbols and other associated parameters.

In another implementation, blind decoding parameters may be changed such that the blind decoding parameters (e.g., a number of control channel elements (CCEs), aggregation levels, candidate locations, or number of blind decoding (BD) budget or attempts associated to a search space or group of search spaces) may be changed from a single slot to multiple slots, or vice versa using dynamic signaling as explained above. Each slot group includes X-consecutive slots and the slot groups are consecutive and non-overlapping. The start of the first slot group in a subframe is aligned with the subframe boundary, while the start of each slot group is aligned with a slot boundary. There can be a common BD budget for all search spaces associated with single slot and multiple slots. The BD budget value may be dynamically signaled between single slot and multiple slots using dynamic signaling. The search space can be adapted or updated with respect to a single slot or multiple ‘x’ consecutive slots.

A span is a number of consecutive symbols in a slot where the UE is configured to monitor PDCCH. Each PDCCH monitoring occasion is within one span or a set of consecutive spans which may itself be configured in consecutive slots. For Group SS configuration 1: A synchronization signal (SS) is configured to be within YGroup1 consecutive slots within a slot group of X slots; The location of the YGroup1 consecutive slots within a slot group of X slots is based on a time offset within the slot group based on slot index no determined for Group (2) monitoring such that the YGroup1 slots overlap the YGroup2 slots; The location of the YGroup 1 consecutive slots within a slot group of X slots is maintained across different slot groups (unless no changes); BD attempts for all Group (1) SSs are restricted to fall within the same YGroup1 consecutive slots. For Group (2) SS, a SS is configured to be within YGroup2 consecutive slots within a slot group of X slots, and the location of the YGroup2 consecutive slots within a slot group of X slots is maintained across different slot groups (unless no changes). All of these parameters can be dynamically switched in one or more combinations.

A UE may be informed by a BS, or the UE may be autonomously chosen and inform the BS by UL signaling as to whether the capability restriction on the maximum number of blind decoding attempts can be over a single slot or a multiple slot. The UE may be informed by the BS or the UE may autonomously chose and inform the BS by UL signaling as to whether the number of PDCCH candidates to be monitored for a search space or search space group set is over a single slot or ‘N’ consecutive slots, starting from slot ‘N−x’.

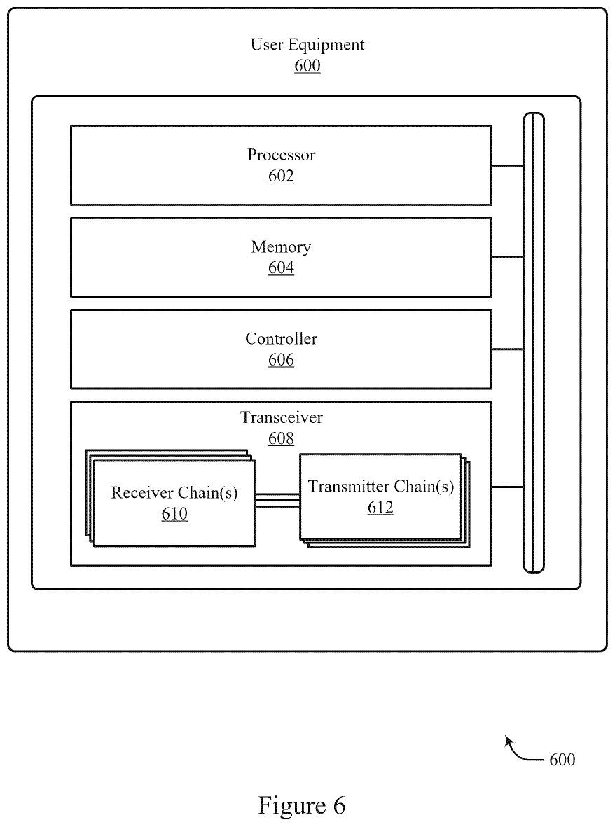

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for.

Additionally, the UE 600 may be configured to support any one or combination of receiving a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; receiving an indication of one or more modified parameters based on a trigger event; and monitoring for a downlink communication based on the one or more modified parameters.

Additionally, or alternatively, the UE 600 may support at least one memory (e.g., the memory 604) and at least one processor (e.g., the processor 602) coupled with the at least one memory and configured to cause the UE to receive a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; receive an indication of one or more modified parameters based on a trigger event; and monitor for a downlink communication based on the one or more modified parameters.

Additionally, the UE 600 may be configured to support any one or combination of the at least one processor configured to cause the UE 600 to receive an indication to switch from a first subset of the multiple subsets of parameters to a second subset of the multiple subsets of parameters, where monitoring for the downlink communication is based on the second subset of the multiple subsets of parameters.

Additionally, the UE 600 may be configured to support any one or combination of the at least one processor configured to cause the UE 600 to modify a quantity of symbols for a respective CORESET based on the indication of the one or more modified parameters. Additionally, the UE 600 may be configured to support any one or combination of the at least one processor configured to cause the UE 600 to receive an indication of one or more carriers associated with the one or more modified parameters.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

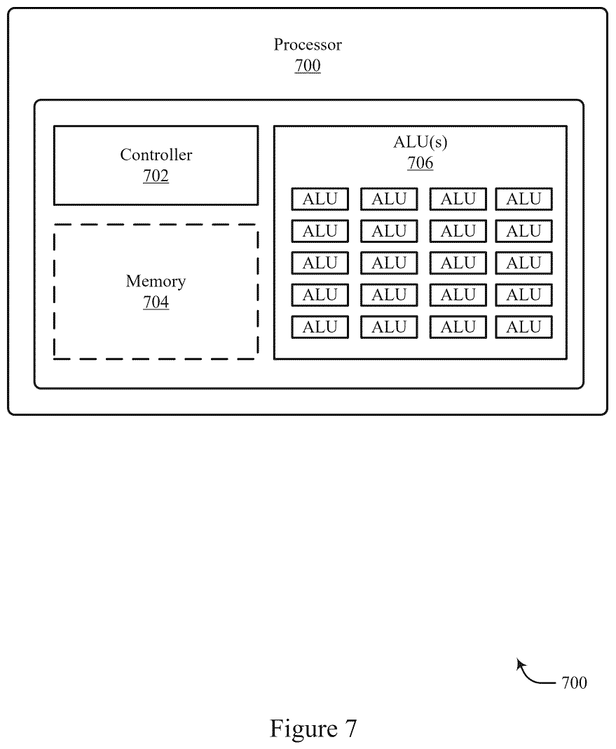

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 707. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; receive an indication of one or more modified parameters based on a trigger event; and monitor for a downlink communication based on the one or more modified parameters.

Additionally, the processor 700 may be configured to or operable to support any one or combination of receiving an indication to switch from a first subset of the multiple subsets of parameters to a second subset of the multiple subsets of parameters, where monitoring for the downlink communication is based on the second subset of the multiple subsets of parameters.

Additionally, the processor 700 may be configured to or operable to support any one or combination of modifying a quantity of symbols for a respective CORESET based on the indication of the one or more modified parameters. Additionally, the processor 700 may be configured to or operable to support any one or combination of receiving an indication of one or more carriers associated with the one or more modified parameters.

Moreover, the processor 700 may be configured to or operable to support at least one controller (e.g., the controller 702) coupled with at least one memory (e.g., the memory 704) and configured to cause the processor to transmit a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; transmit an indication of one or more modified parameters based on a trigger event; and transmit a downlink communication based on the one or more modified parameters.

Additionally, the processor 700 may be configured to or operable to support any one or combination of transmitting an indication of one or more carriers associated with the one or more modified parameters.

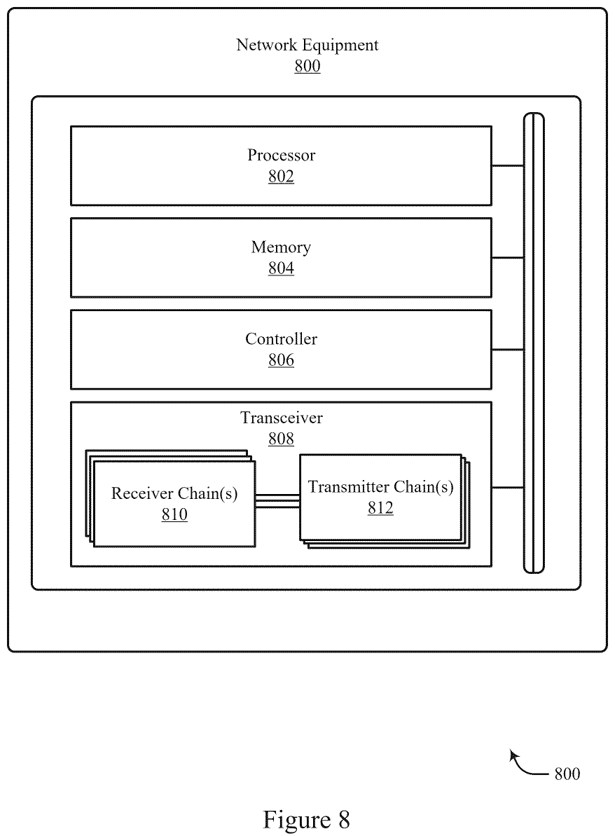

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; transmitting an indication of one or more modified parameters based on a trigger event; and transmitting a downlink communication based on the one or more modified parameters.

Additionally, or alternatively, the NE 800 may support at least one memory (e.g., the memory 804) and at least one processor (e.g., the processor 802) coupled with the at least one memory and configured to cause the NE to transmit a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs; transmit an indication of one or more modified parameters based on a trigger event; and transmit a downlink communication based on the one or more modified parameters.

Additionally, the NE 800 may be configured to support any one or combination of the at least one processor configured to cause the NE 800 to transmit an indication of one or more carriers associated with the one or more modified parameters.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

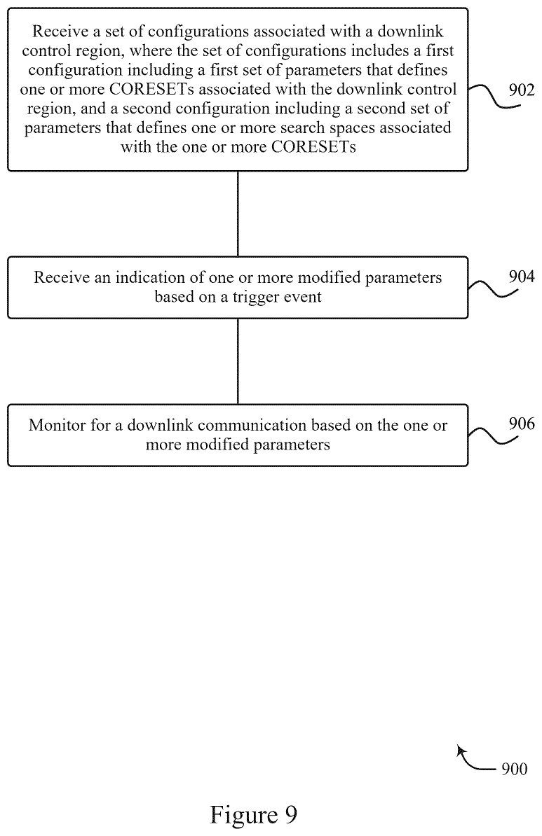

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs. The operations of 902 may be performed in accordance with examples as described herein. In some implementations, aspects of the operations of 902 may be performed by the UE 600 as described with reference to FIG. 6.

At 904, the method may include receiving an indication of one or more modified parameters based on a trigger event. The operations of 904 may be performed in accordance with examples as described herein. In some implementations, aspects of the operations of 904 may be performed by the UE 600 as described with reference to FIG. 6.

At 906, the method may include monitoring for a downlink communication based on the one or more modified parameters. The operations of 906 may be performed in accordance with examples as described herein. In some implementations, aspects of the operations of 906 may be performed the UE 600 as described with reference to FIG. 6.

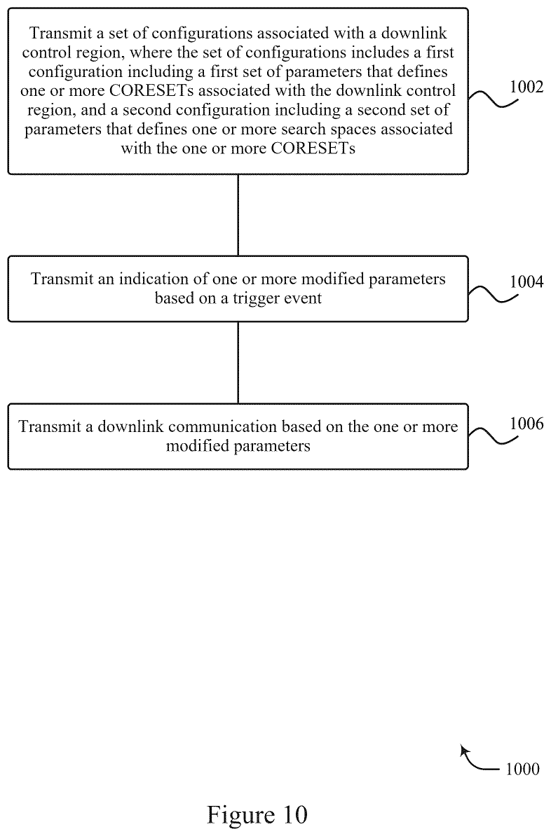

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting a set of configurations associated with a downlink control region, where the set of configurations includes a first configuration including a first set of parameters that defines one or more CORESETs associated with the downlink control region, and a second configuration including a second set of parameters that defines one or more search spaces associated with the one or more CORESETs. The operations of 1002 may be performed in accordance with examples as described herein. In some implementations, aspects of the operations of 1002 may be performed by the NE 800 as described with reference to FIG. 8.

At 1004, the method may include transmitting an indication of one or more modified parameters based on a trigger event. The operations of 1004 may be performed in accordance with examples as described herein. In some implementations, aspects of the operations of 1004 may be performed by the NE 800 as described with reference to FIG. 8.

At 1006, the method may include transmitting a downlink communication based on the one or more modified parameters. The operations of 1006 may be performed in accordance with examples as described herein. In some implementations, aspects of the operations of 1004 may be performed by the NE 800 as described with reference to FIG. 8.

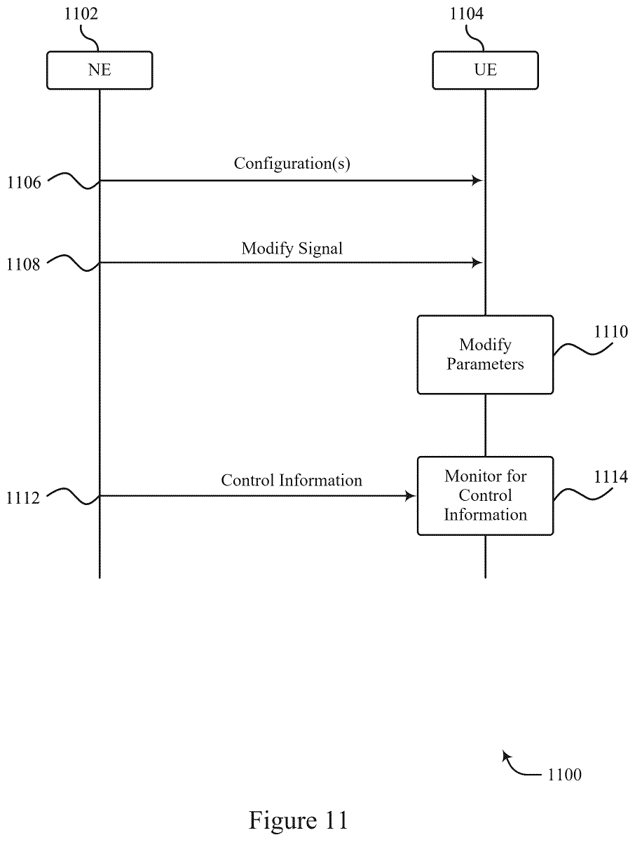

FIG. 11 illustrates a process flow 1100 in accordance with aspects of the present disclosure. In some examples, the process flow 1100 may be performed by a UE 1104 which may be an example of the UE 104, the UE 204, or the UE 600 as described with reference to FIGS. 1, 2, and 6, respectively. Moreover, the process flow 1100 may be performed by an NE 1102 which may be an example of the NE 102, the NE 202, or the NE 800 as described with reference to FIGS. 1, 2, and 8 respectively.

At 1106, the UE 1104 may receive, from the NE 1102, a set of configurations associated with a downlink control region. The set of configurations may include a first configuration including a first set of parameters that defines one or more CORESETs associated with the downlink control region, and a second configuration including a second set of parameters that defines one or more search spaces associated with the one or more CORESETs. In some examples, the first set of parameters or the second set of parameters includes multiple subsets of parameters, each subset of the multiple subsets of parameters including at least one same parameter. In some examples, a value assigned to the at least one same parameter differs between each subset of the multiple subsets of parameters. One or more parameters of the first configuration may include a set of time resources for a respective CORESET, a set of frequency resources for the respective CORESET, or a DMRS density for the respective CORESET. Additionally, one or more parameters of the second configuration may include a set of slots for monitoring PDCCH, a subset of slots for multi-slot monitoring PDCCH, a beginning symbol of a respective slot for monitoring PDCCH, a quantity of PDCCH candidates per AL for a respective search space, or a quantity of ALs for the respective search space.

At 1108, the UE 1104 may receive, from the NE 1102, a modify signal that includes an indication of one or more modified parameters based on a trigger event. Additionally, the modify signal may indicate one or more carriers associated with the one or more modified parameters. In some examples, the trigger event may include an expiration of a timer or a BWP change of the UE 1104. The modify signal may be received as part of DCI, a MAC-CE, or a low power radio signal.

At 1110, the UE 1104 may modify the one or more parameters based on the one or more modified parameters. In one example, the UE 1104 may switch from a first subset of the multiple subsets of parameters to a second subset of the multiple subsets of parameters. As another example, the UE 1104 may update a quantity of symbols allocated to a CORESET.

At 1112, the NE 1102 may transmit, to the UE 1104, control information in accordance with the one or more modified parameters.

At 1114, the UE 1104 may monitor for control information from the NE 1102 in accordance with the one or more modified parameters.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a set of configurations associated with a downlink control region, wherein the set of configurations comprises a first configuration including a first set of parameters that defines one or more control resource sets (CORESETs) associated with the downlink control region, and a second configuration including a second set of parameters that defines one or more search spaces associated with the one or more CORESETs;
receive an indication of one or more modified parameters based at least in part on a trigger event; and
monitor for a downlink communication based at least in part on the one or more modified parameters.

2. The UE of claim 1, wherein each of the one or more CORESETs is associated with a respective CORESET identifier (ID), and one or more parameters of the first configuration comprises one or more of:
a set of time resources for a respective CORESET;
a set of frequency resources for the respective CORESET; or
a demodulation reference signal (DMRS) density for the respective CORESET.

3. The UE of claim 1, wherein one or more parameters of the second configuration comprises one or more of:
a set of slots for monitoring physical downlink control channel (PDCCH);
a subset of slots for multi-slot monitoring PDCCH;
a beginning symbol of a respective slot for monitoring PDCCH;
a quantity of PDCCH candidates per aggregation level (AL) for a respective search space; or
a quantity of ALs for the respective search space.

4. The UE of claim 1, wherein the first set of parameters or the second set of parameters comprises multiple subsets of parameters, each subset of the multiple subsets of parameters comprising at least one same parameter, wherein a value assigned to the at least one same parameter differs between each subset of the multiple subsets of parameters.

5. The UE of claim 4, wherein, to receive the indication of the one or more modified parameters, the at least one processor is operable to cause the UE to:
receive an indication to switch from a first subset of the multiple subsets of parameters to a second subset of the multiple subsets of parameters, wherein monitoring for the downlink communication is based at least in part on the second subset of the multiple subsets of parameters.

6. The UE of claim 1, wherein the at least one processor is further operable to cause the UE to:
modify a quantity of symbols for a respective CORESET based at least in part on the indication of the one or more modified parameters.

7. The UE of claim 1, wherein the at least one processor is further operable to cause the UE to:
receive an indication of one or more carriers associated with the one or more modified parameters.

8. The UE of claim 1, wherein the trigger event comprises an expiration of a timer or a change in a bandwidth part (BWP) associated with the UE.

9. The UE of claim 1, wherein downlink control information (DCI), a medium access control-control element (MAC-CE), or a low power radio signal comprises the indication of the one or more modified parameters.

10. A method performed by a user equipment (UE), comprising:
receiving a set of configurations associated with a downlink control region, wherein the set of configurations comprises a first configuration including a first set of parameters that defines one or more control resource sets (CORESETs) associated with the downlink control region, and a second configuration including a second set of parameters that defines one or more search spaces associated with the one or more CORESETs;
receiving an indication of one or more modified parameters based at least in part on a trigger event; and
monitoring for a downlink communication based at least in part on the one or more modified parameters.

11. A network equipment (NE) for wireless communication, comprising:
at least one memory; and
at least one processor coupled with the at least one memory and operable to cause the NE to:
transmit a set of configurations associated with a downlink control region, wherein the set of configurations comprises a first configuration including a first set of parameters that defines one or more control resource sets (CORESETs) associated with the downlink control region, and a second configuration including a second set of parameters that defines one or more search spaces associated with the one or more CORESETs;
transmit an indication of one or more modified parameters based at least in part on a trigger event; and
transmit a downlink communication based at least in part on the one or more modified parameters.

12. The NE of claim 11, wherein each of the one or more CORESETs is associated with a respective CORESET identifier (ID), and one or more parameters of the first configuration comprises one or more of:
a set of time resources for a respective CORESET;
a set of frequency resources for the respective CORESET; or
a demodulation reference signal (DMRS) density for the respective CORESET.

13. The NE of claim 11, wherein one or more parameters of the second configuration comprises one or more of:
a set of slots for monitoring physical downlink control channel (PDCCH);
a subset of slots for multi-slot monitoring PDCCH;
a beginning symbol of a respective slot for monitoring PDCCH;
a quantity of PDCCH candidates per aggregation level (AL) for a respective search space; or
a quantity of ALs for the respective search space.

14. The NE of claim 11, wherein the first set of parameters or the second set of parameters comprises multiple subsets of parameters, each subset of the multiple subsets of parameters comprising at least one same parameter, wherein a value assigned to the at least one same parameter differs between each subset of the multiple subsets of parameters.

15. The NE of claim 14, wherein the indication of the one or more modified parameters comprises an indication to switch from a first subset of the multiple subsets of parameters to a second subset of the multiple subsets of parameters, wherein transmitting the downlink communication is based at least in part on the second subset of the multiple subsets of parameters.

16. The NE of claim 11, wherein the indication of the one or more modified parameters comprises an indication to modify a quantity of symbols for a respective CORESET.

17. The NE of claim 11, wherein the at least one processor is further operable to cause the NE to:
transmit an indication of one or more carriers associated with the one or more modified parameters.

18. The NE of claim 11, wherein the trigger event comprises an expiration of a timer or a change in a bandwidth part (BWP) associated with a user equipment (UE).

19. The NE of claim 11, wherein downlink control information (DCI), a medium access control-control element (MAC-CE), or a low power radio signal comprises the indication of the one or more modified parameters.

20. A method performed by a network equipment (NE), comprising:
transmitting a set of configurations associated with a downlink control region, wherein the set of configurations comprises a first configuration including a first set of parameters that defines one or more control resource sets (CORESETs) associated with the downlink control region, and a second configuration including a second set of parameters that defines one or more search spaces associated with the one or more CORESETs;
transmitting an indication of one or more modified parameters based at least in part on a trigger event; and
transmitting a downlink communication based at least in part on the one or more modified parameters.
